(19) United States
(12) Patent Application Publication
(10) Pub. No.: US 2012/0185308 A1
(43) Pub. Date: Jul. 19, 2012

(54) METHOD OF PROTECTING COPYRIGHT OF DIGITAL PUBLICATION AND THE SYSTEM THEREFOR

(76) Inventor: Chao-Ming SHIH, ChongHe City (TW)

(21) Appl. No.: 13/430,256

(22) Filed: Mar. 26, 2012

Related U.S. Application Data
(63) Continuation of application No. 11/095,597, filed on Apr. 1, 2005.

(30) Foreign Application Priority Data
Apr. 8, 2004 (TW) 93109683

(51) Int. Cl. G06Q 30/02

(52) U.S. Cl. 705/14.4

(57) ABSTRACT

A method of protecting the copyright of a digital publication includes the steps of obtaining a file and a copyright licensing certificate of at least one digital publication, or obtaining at least one digital publication file and then obtaining a corresponding copyright licensing certificate at a position specified in the file; and verifying the copyright licensing certificate so as to retrieve information about the reduction process, the authority of use, the file position and contents of the digital publication recorded in the certificate, so that the digital publication file may be played, used, accessed, or shared via an operational unit. The digital publication file may be transferred or copied to other operational unit as necessary, and the copyright licensing certificate may be split, merged, etc. to allow sharing, transmitting, and transferring of the digital publication file and the copyright licensing certificate among different operational units.

### CROSS-REFERENCE TO RELATED APPLICATION

This application is a continuation application of a prior application Ser. No. 11/095,597, filed Apr. 1, 2005, all disclosures is incorporated therewith. The prior application Ser. No. 11/095,597 claims the priority benefit of Taiwan application serial no. 93109683, filed on Apr. 8, 2004. The entirety of each of the above-mentioned patent applications is hereby incorporated by reference herein and made a part of this specification.

### FIELD OF THE INVENTION

The invention relates to a method of protecting copyright of digital publication and the system therefor, and more particularly to a method of protecting copyright of digital publications, including musical works, movies, stream audio/visual (AV) data, electronic games, E-journals, software, etc., and the system therefor.

### BACKGROUND OF THE INVENTION

The currently commercially available digital publication protection systems are generally built on a Digital Rights Management (DRM) technique, which is adapted to protect contents of digital media against unauthorized distribution, publicizing, and selling over networks. That is, the DRM technique is implemented via a computer, and includes the procedures of (1) packaging a digital publication, including compression and encryption thereof; (2) issuing the digital publication; (3) licensing copyright of the digital publication, including giving an encrypted key and restricting the scope of use of the digital publication; and (4) allowing the reproduction, use, or play of the digital publication.

The DRM technique is characterized in that it separates the obtaining of a digital publication from the licensing of copyright of the digital publication. In other words, a user obtaining a digital publication without obtaining the copyright licensing thereof is still not entitled to enjoy the contents of the digital publication. A License Server is responsible for the licensing of the digital publication, and the licensing mechanism is typically an online operation.

Meanwhile, since the DRM technique is built on the Internet environment, it is directed to users who know the way to enter the Internet via a computer. As a result, the computer and peripherals thereof become the major equipment for storing, playing, and using the digital publication.

However, it is found the current digital publication licensing mechanism does not take the following factors into consideration:
1. Not all the equipment for playing or using the digital publication must or would be connected to the Internet.
2. The current copyright management system does not respect or consider the consumer's need for reasonable use or reproduction of the digital publication after purchasing the same.
3. There are not reasonable rules for synchronously transmitting the license to a digital publication when the latter is transmitted among different operational units.
4. For a digital publication that is transmitted or exchanged in an offline state, there is not any solution for the license thereto to be synchronously updated or maintained as purchased in an offline state.

It is therefore tried by the inventor to develop a method and system for protecting the copyright of a digital publication that not only overcomes the drawbacks and disadvantages existed in the conventional systems or techniques for protecting the copyright of digital publications, but also covers all the current mechanisms for managing and protecting the copyright of digital publications, so as to ensure a digital publication copyright owner' rights and interests, and allow all consumers to use the digital publications on any available play device, allowing the copyright of digital publications to be more conveniently transmitted.

### SUMMARY OF THE INVENTION

A primary object of the present invention is to provide a method and system for protecting copyright of digital publication that is applicable to all currently available mechanisms for managing and protecting the copyright of digital publications, so as to ensure a digital publication copyright owner's rights and interests.

To achieve the above and other objects, the method of protecting copyright of digital publication according to the present invention includes the steps of obtaining a file and a copyright licensing certificate of at least one digital publication, or obtaining at least one digital publication file and then obtaining a corresponding copyright licensing certificate at a position specified in the file; and verifying the copyright licensing certificate so as to retrieve information recorded in the certificate, including the reduction process, the authority of use, the file position and contents of the digital publication, so that the digital publication file may be played, used, accessed, or shared via an operational unit. The digital publication file may be transferred or copied to other operational units as necessary, and the copyright licensing certificate may be split, merged, etc. to allow sharing, transmitting, and transferring of the digital publication file and the copyright licensing certificate among different operational units. In this manner, it is possible to protect the lawful copyright of the digital publication.

And, the system for protecting copyright of digital publication according to the present invention includes at least one digital publication file, at least one copyright licensing certificate, at least one operational unit, and at least one multimedia gate server. Wherein, the digital publication file is a digital publication containing digital media contents; the copyright licensing certificate is for controlling or limiting a user's authority to use the digital publication file in a normal way; the operational unit is internally provided with a built-in storage module, a play device control element, and a digital publication processing unit for storing and playing the digital publication file; and the multimedia gate server has large quantities of digital publication files and copyright licensing certificates stored therein, and allows the operational unit to connect thereto to share the digital publication files therein in an online state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual diagram showing file formats of a digital publication before and after packaging, according to the present invention;

FIG. 2 is a block diagram showing a copyright certification module according to the present invention;

FIG. 3 is a block diagram showing a storage module according to the present invention;

FIG. 4 is a conceptual diagram showing the use of a digital publication file over networks according to the present invention;

FIG. 5 is a conceptual block diagram showing a general operational unit according to the present invention;

FIG. 6 is a block diagram showing an online-enable operational unit according to the present invention;

FIG. 7 is a conceptual block diagram showing a multimedia gate server according to the present invention;

FIG. 8 is a diagram showing the system architecture of a remote digital publication service center according to the present invention;

FIG. 9 is a diagram showing the configuration of hardware having a certification module according to the present invention;

FIG. 10 is a flowchart showing the steps of using a digital publication according to the present invention;

FIG. 11 is a flowchart showing the steps of splitting or merging a copyright licensing certificate according to the present invention;

FIG. 12 is a flowchart showing the steps of sharing a copyright licensing certificate in an offline state according to the present invention; and

FIG. 13 is a flowchart showing the steps of sharing a copyright licensing certificate in an online state according to the present invention.

### DETAILED DESCRIPTION OF THE PREFERRED EMBODIMENTS

The present invention is a copyright protection and management mechanism designed to manage and protect a digital publication and the copyright thereof, particularly a digital publication containing digital media contents, such as musical works, audio/visual (AV) data, software, E-journals, and/or electronic games. In a system architecture for the copyright protection and management mechanism of the present invention, there are included a digital publication file 100, a copyright licensing certificate 200, an operational unit 300, a multimedia gate server 400, and a remote digital publication service center 500.

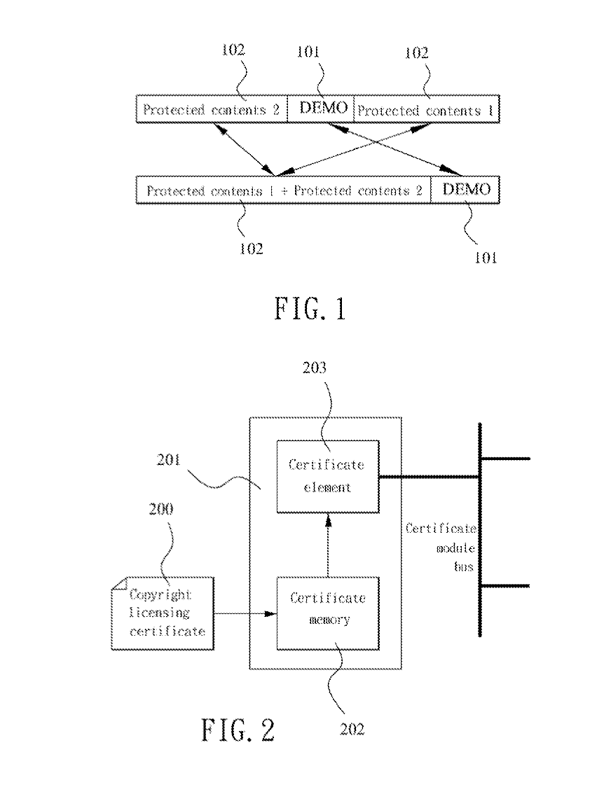

Please refer to FIG. 1 that is a conceptual diagram showing file formats of a digital publication before and after packaging according to the present invention. As having been mentioned above, while a digital publication file 100 protected by the present invention is transmittable to different positions, its correct content is not available for a user without license to the digital publication.

Most copyright protection systems would first encrypt and package the digital publication file. Here, packaging a digital publication file means packaging software format instead of packaging any hardware or any physical packaging. When a user intends to use a packaged digital publication file without obtaining a copyright licensing certificate 200 thereof, either a group of scrambled codes are shown or an interrupted play or operation occurs.

However, the system of the present invention for protecting copyright of digital publication is not designed to produce scrambled codes only, but to allow a user to enjoy some parts of the digital publication, such as a beginning part thereof, an attractive advertisement thereof, or some attractive pictures thereof, which are generally referred to as the demonstration part or “DEMO” 101, even when the user has not yet obtained the copyright of the digital publication. Only the part of the digital publication other than the DEMO 101 is a protected content 102 that is protected through licensing. A user is entitled to play or operate the protected content 102 of the digital publication file only when the copyright licensing certificate 200 thereof has been obtained. In the event the copyright licensing certificate 200 is not obtained or the copyright licensing certificate 200 is expired, the protected content 102 of the digital publication file is output in the form of packaged and scrambled codes, or is interrupted from playing. And, even if the packaged digital publication file 100 is played or used via a normal or standard operational unit or software, the user without license could still not access the protected content 102.

The operational unit used in the present invention is not limited to any particular specification. The digital publication file 100 is sent to a standard operational unit or software, and the protected content 102 in the digital publication file 100 is reduced to a normal format or content before packaging by way of using a reduction process recorded in the licensing certificate 200. Thereafter, the DEMO 101 and the protected content 102 are combined in an original sequence and output. Please refer to FIG. 1, an upper part of which shows a file sequence having the reduced file content 102, and a lower part of which shows a file sequence divided into the protected file content 102 and the playable DEMO 101. When the digital publication file 100 is played without the copyright licensing certificate 200, the output thereof includes the advertisements and the demonstration part 101 of the file, and scrambled codes of the protected file content 102, as shown in the lower part of FIG. 1. And, when the digital publication file 100 is played with the copyright licensing certificate 200, the file sequence is reduced and readable data, including the file content 102 and the DEMO 101, are output, as shown in the upper part of FIG. 1.

Please refer to FIG. 2 that is a block diagram of the copyright licensing certificate 200. In the present invention, the copyright licensing certificate 200 provides not only information about the reduction process of the digital publication file 100, but also the function of controlling or limiting a user's authority to use the digital publication file 100 in a normal way. To achieve this controlling or limiting function, the copyright licensing certificate 200 is processed using a certification module 201.

To ensure that the copyright licensing certificate 200 is not maliciously reproduced or decrypted, the copyright licensing certificate 200 is stored in a certificate memory 202 sealed in the certification module 201. As can be seen from FIG. 2, the certificate memory 202 of the certification module 201 supplies a copyright licensing certificate 200 for identifying the legal copyright of the digital publication file 100. When the copyright licensing certificate 200 is output along with the digital publication file 100, it is encrypted using a certification element 203 of the certification module 201 to minimize the possibility of being illegally used on other operational units. In other words, an encrypted copyright licensing certificate 200 is still possibly decrypted, if it were arbitrarily transmitted among different users. On the other hand, when the copyright licensing certificate 200 is stored in the certification module 201, a user's authority to access the copyright licensing certificate 200, the scope within which related data can be accessed, or the manner in which related data can be accessed may be limited using the certification element 203 in the certification module 201, so that the copyright licensing certificate 200 is not arbitrarily read or decrypted, and therefore highly protected.

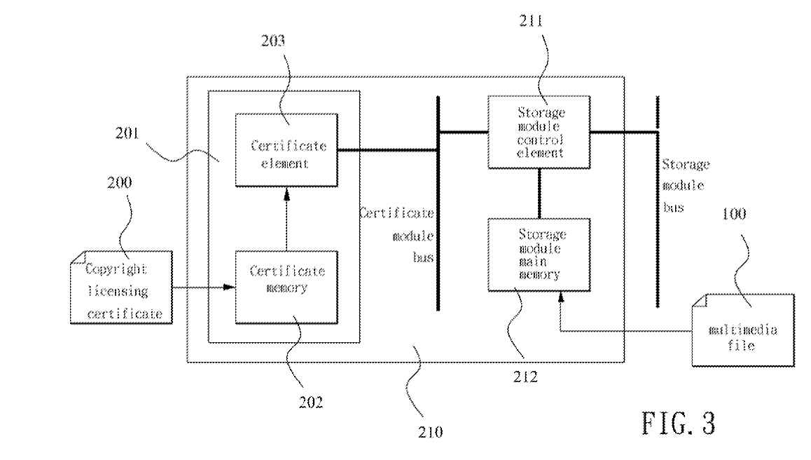

Please refer to FIG. 3 that is a block diagram of a storage module 210 included in the system of the present invention. The packaged digital publication file 100 is stored in the storage module 201 but outside the certification module 201. The storage module 210 provides the digital publication file 100 and the copyright licensing certificate 200, and includes a storage module control element 211 for controlling data exchange between a storage module main memory 212 and the certification module 201. The storage module control element 211 is also an interface via which data exchange between the storage module 210 and other units is performed.

All other operations that may be done against the copyright licensing certificate 200, including accessing, merging, or splitting thereof, are done on a play device connected to the storage module 210. The certification element 203 of the certification module 201 supervises and controls a user's authority to access the copyright licensing certificate 200, while the certification module 201 operates to limit the output of the digital publication file 100.

When it is discovered by the certification module 201 that the copyright licensing certificate 200 is incorrect or exceeds a preset licensed part, only the DEMO part 101 of the digital publication file 100 is output. The protected content 102 of the file 100 is not output or output in the form of scrambled codes. Reversely, when the copyright licensing certificate 200 is found correct and meeting the preset licensed part, the digital publication file 100 and corresponding reduction information are fully output.

In practical use of the present invention, in consideration of the cost of the storage module 210, the popularization of networks, and the trend in stream data, the storage module main memory 212 in the storage module 210, which is a source of the digital publication file 100, may have different forms, including a memory card, a hard disk, a network virtual disk, a source of stream data, or a multimedia data transmitted via wireless communication. Therefore, in the present invention, the packaged digital publication file 100 may also be positioned outside the certification module 201 or the storage module 210.

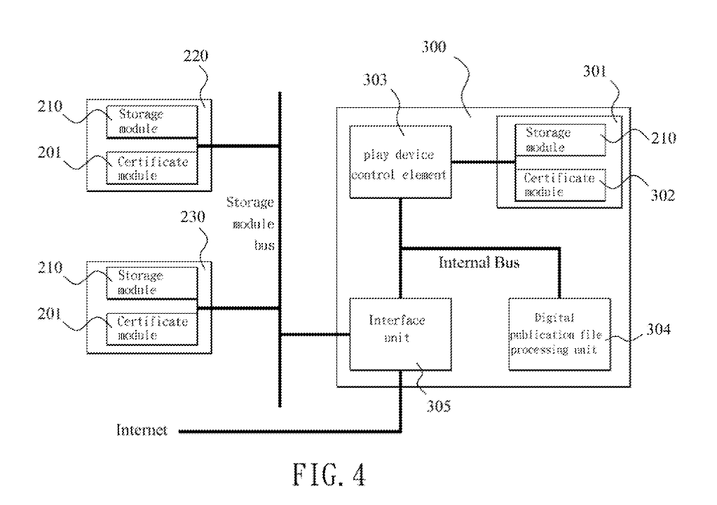

FIG. 4 is a conceptual diagram showing the use of a digital publication file over networks via an operational unit 300 according to the present invention. In the present invention, hardware having only the certification module 201 packaged therein is referred to as a copyright control card 220; and hardware having both the storage module 210 and the certification module 201 packaged therein is referred to as a removable storage device 230.

The operational unit 300 includes a built-in storage module 301, in which there is provided a copyright certification module 302. The copyright certification module 302 has three functions: (1) it works with the certification module 201 in the copyright control card 220 to verify each other, so as to obtain information about the position of the digital publication file 100 and the reduction process thereof, or to perform necessary operation against the licensing certificate 200 in the copyright control card 220 when a positive result is shown in the mutual verification; (2) it works with the certification module 201 in the removable storage device 230 to verify each other, so as to use the digital publication file 100 and the reduction information stored in the removable storage device 230, or to perform necessary operation against the licensing certificate 200 in the removable storage device 230 when a positive result is shown in the mutual verification; and (3) it controls and uses its own copyright licensing certificate 200 and the digital publication file 100 in the built-in storage module 301.

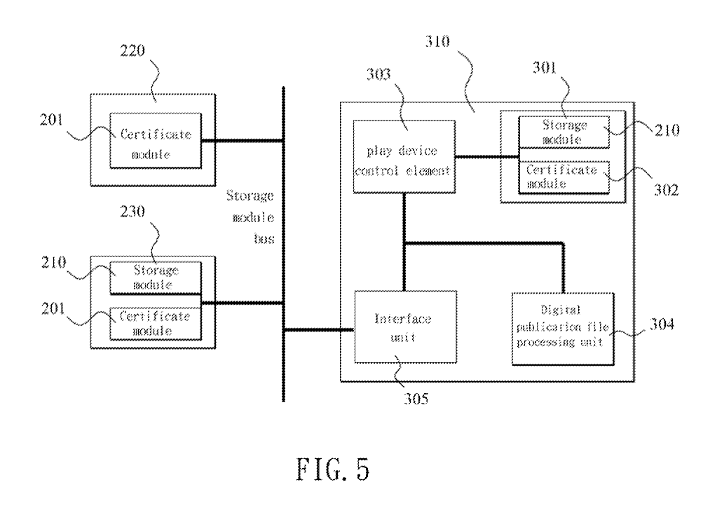

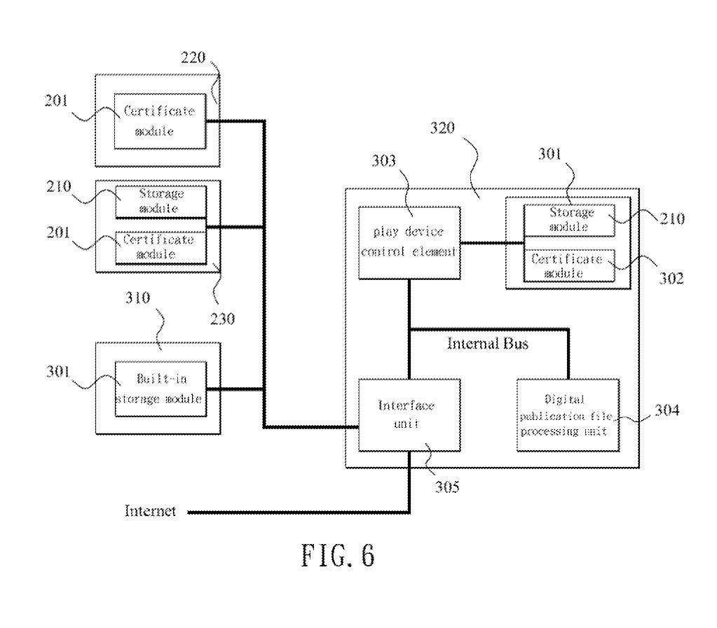

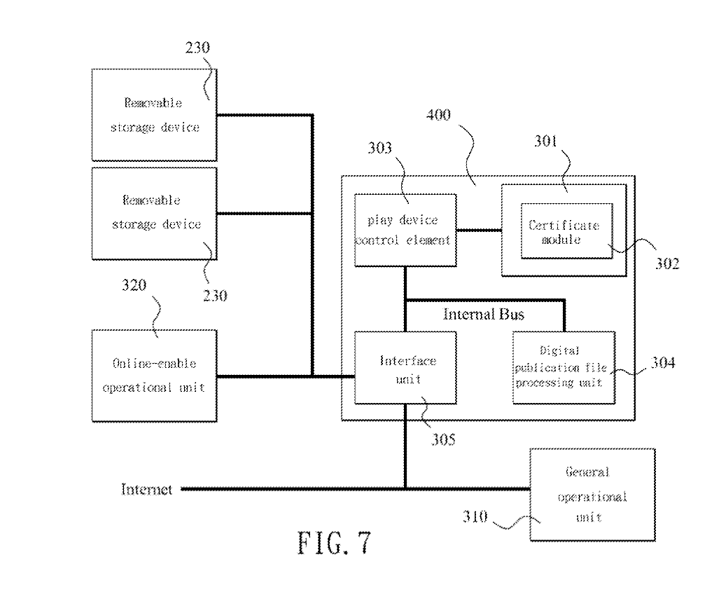

The operational unit 300 may be further divided into a general operational unit 310 and an online-enable operational unit 320 according to the function thereof. FIG. 5 is a conceptual block diagram showing the general operational unit 310, and FIG. 6 is a block diagram showing the online-enable operational unit 320. The general operational unit 310 may directly play the digital publication file 100 stored on the built-in storage module 301, or use the digital publication file 100 stored on the removable storage device 230 after a successful verification.

Via the general operational unit 310, it is also possible to reproduce, delete, or move the digital publication file 100 on the removable storage device 230, and to merge, split, transmit, or transfer the copyright licensing certificate 200 corresponding to the digital publication file 100 and the copyright licensing certificate 200 stored on the copyright control card 220. Moreover, the above-mentioned operations may be performed between two similar or different devices in the copyright control card 220 and the removable storage device 230, between the copyright control card 220 and the built-in storage module 301, between the copyright control card 220 and the built-in storage module 301, or between the removable storage device 230 and the built-in storage module 301. However, this function is not prerequisite for the general operational unit 310.

In the online-enable operational unit 320, the built-in storage module 301 thereof may have functions similar to that of the removable storage device 230 or to that of the copyright control card 220. In the former case, the online-enable operational unit 320 has all the functions of the general operational unit 310. The online-enable operational unit 320 has the functions of reproducing, deleting, or moving the digital publication file 100, and of merging, splitting, transmitting, or transferring the copyright licensing certificate 200 corresponding to the digital publication file 100, while the general operational unit 310 might not have these functions.

The online-enable operational unit 320 is different from the general operational unit 310 mainly in that the operational unit 320 provides itself and other general operational unit 310 or removable storage device 230 or copyright control card 220 connected thereto with the ability of online purchasing new digital publication file 100 or license thereto, or online purchasing the license to a new digital publication file 100, or online updating the license to an old digital publication file 100.

Both the general operational unit 310 and the online-enable operational unit 320 have an internal play device control element 303, a digital publication file processing unit 304, and an interface unit 305. The play device control element 303 is in charge of internal control and management of the operational unit 310, 320, as well as the control and management of data exchange and all kinds of operations between the operational units 310, 320 and all other units connected thereto. Moreover, the play device control element 303 also sends the digital publication file 100, which has be successfully certified by the built-in storage module 301, to the digital publication file processing unit 304 for playing, using, or accessing. The interface unit 305 is connected to a general operational unit 310 (see FIG. 6), or to the copyright control card 220 and/or the removable storage device 230 (see FIG. 4), or to other apparatus via a network system. The interface unit 305 of the online-enable operational unit 320 may also be connected to a remote digital publication service center to provide a source of different files.

Please refer to FIG. 7 that is a conceptual block diagram showing the multimedia gate server 400 in the system of the present invention. In the present invention, the multimedia gate server 400 not only has the same functions as the online-enable operational unit 320, but also the function of allowing all the general operational units 310, the online-enable operational units 320, the copyright control cards 220, and the removable storage devices 230 connected thereto, and the multimedia gate server 400 itself, to share and manage the digital publication file 100 and the copyright licensing certificate 200. Since the multimedia gate server 400 has internal parts and operation similar to that shown in FIG. 6, it is not repeatedly described herein.

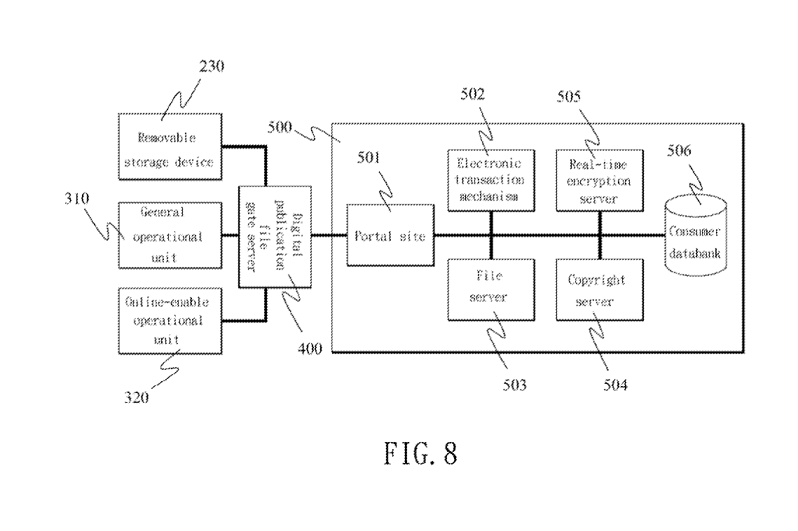

Please refer to FIG. 8 that is a diagram showing a system architecture of the remote digital publication service center 500 in the system of the present invention. To enable accomplishment of an E-commerce system that could actually implement the system of the present invention for protecting copyright of digital publication, the remote digital publication service center 500 includes a portal site 501, a secure electronic transaction (SET) system 502, a file server 503, a copyright server 504, and a real-time encryption server 505. Other functions required by general E-commerce systems are provided depending on actual need.

The functions and purposes of the remote digital publication service center 500 include: (1) providing a storing space for the digital publication files 100 to be sold (by the file server 503); (2) creating the required copyright licensing certificate 200 in the selling (by the copyright server 504); (3) providing operating procedures and cash flow required in electronic transaction, and ensuring the security thereof (by the portal site 501 and the SET system 502); and (4) creating different encryption results depending on different licensees or different licensing manners (by the real-time encryption server 505).

The way to provide the digital publication file 100 to be sold with a storing space is to set up a file server 503. In consideration of product security, the digital publication file 100 is usually stored in an encrypted and packaged format, which is not necessary the file format received by a user. When necessary, the digital publication file 100 is further encrypted at the real-time encryption server 505 before being transmitted to a user.

The copyright server 504 is required to create different original copyright licensing certificates 200. The copyright licensing certificates 200 on the copyright server 504 may be divided into two types according to the way in which they are created. The first type of the copyright licensing certificate 200 is created at the time the copyright owner licenses the sale of the digital publication. This type of copyright licensing certificate 200 is temporarily store on the copyright server 504 until it is sold.

For instance, there are 1000 products (that is, the digital publication files 100) to be sold under license. These 1000 digital publication files 100 are encrypted and packaged in different manners before selling, so as to create 1000 corresponding copyright licensing certificates 200. Thus, the product purchased by a user is always unique. Moreover, information about the purchaser may be added to the copyright licensing certificate 200 before the selling of the product, so as to create a named or personal licensing certificate.

Alternatively, the copyright owner may select not to create all the copyright licensing certificates 200 at the time of licensing the sale of the product. This is the second type of the copyright licensing certificate 200. There are two possible conditions in creating the second type of copyright licensing certificate 200. In the first condition, a fixed number of user-based licenses are created, such as 10,000 licenses, and a group of copyright licensing certificates 200 containing the 10,000 licenses is created in advance. In selling the product, a part of the 10,000 licenses corresponding to the quantity of product purchased by a consumer is split from the group of copyright licensing certificates 200 and output to the consumer's device. In the second condition, the copyright owner does not create the copyright licensing certificate 200 at the time of licensing the sale of the product, particularly when the number of products to be sold under license is infinite. An appropriate number of copyright licensing certificates 200 is created by the copyright server 504 only at the time of selling depending on the consumer's need. The copyright licensing certificates 200 created in either of the two conditions may be named or unnamed.

For an E-commerce system, one of the most important things is to guide the consumer to complete the transaction and ensure the performance and security of the transaction. For this purpose, there must be a portal site 501 for consumers to easily browse and locate the desired digital publication file 100, and guiding the consumers to complete all necessary operations or procedures, including the selection of desired products, the calculating of amount, the selection of ways of payment, etc.

Generally, the portal site 501 would associate with a consumer databank 506 to record information about the consumer, such as the consumer's personal information, the way of delivery, past purchase records, analyses of consumer's purchasing habits, etc., and to provide other functions, such as allowing the consumer to amend personal information or check past records of purchase, promoting new products based on the analyses of consumers' purchasing habits, etc.

In the present invention, it is not intended to restrict the consumer to any specific way of payment. Therefore, in implementing the present invention, the SET system 502 can be integrated into any and all payment mechanisms currently available in the market, such as payment through credit card, bank account, pre-paid card, point-deduction card, easy card, E-wallet, or advance account or point-deduction account registered by the user in the system of the present invention, so long as the selected way of payment provides secured cash flow control meeting the related electronic transaction regulations.

It has been mentioned above the present invention may provide differently packaged digital publication files 100 and corresponding copyright licensing certificates 200 according to different consumers. The product may be differently packaged before it is put into the system for sale, or at the time it is purchased or delivered. Generally, the packaging is done at the encryption server 505. Since the encryption server 505 has higher operating ability to provide quicker and better service, it is more suitable for the encryption server 505 to handle the operations of encrypting and packaging product, so that the website system is not overloaded. Meanwhile, the encryption server 505 has higher security rank to provide safer encryption format. In the present invention, since the encryption operation is not done at the portal site 501, which is exposed to the front line on the Internet, the chances of having an invaded system are largely reduced.

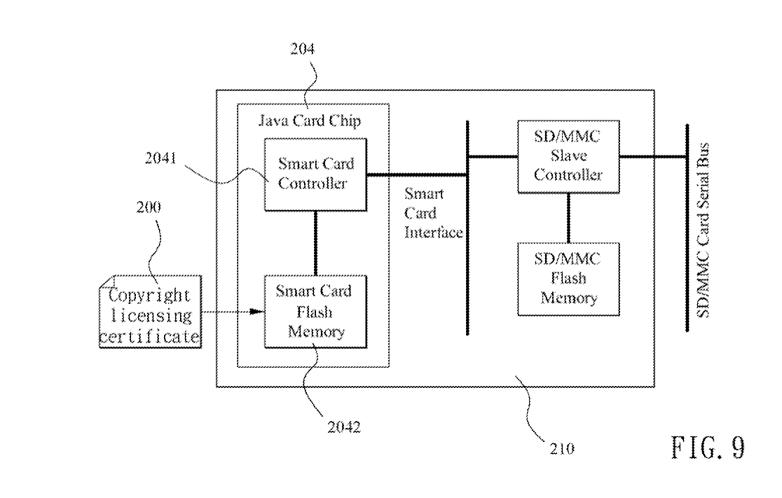

Please refer to FIG. 9 that is a diagram showing the configuration of hardware having a certification module according to the present invention. For the purpose of providing a powerful and sound copyright protection mechanism to ensure that the randomly created copyright licensing certificates 200 are not maliciously reproduced or decrypted, the copyright licensing certificates 200 are stored on the certificate memory 202 sealed in the certification module 201 according to an embodiment of the present invention. FIG. 9 shows a standard memory card configuration, to which a Smart Card chip 204 is added. In FIG. 9, the Smart Card chip 204 is an embodiment of the previously defined certification module 201.

Meanwhile, a security function provided by the Smart Card chip 204 is utilized to execute the protection of the copyright licensing certificate 200 and the certification and operation of the copyright. Thereafter, reserved instructions that are not used by the standard memory card are utilized to automatically increase new instructions for running operations on or accessing the Smart Card chip 204 and the copyright licensing certificate 200. In doing so, the products can be quickly integrated and developed, and the recognized security mechanism provided by the Smart Card chip 204 can be directly used to protect the copyright licensing certificate 200.

When a memory 2042 in the memory card, which is equivalent to the storage module main memory 212, is removed from the configuration of FIG. 9, an accessing device having only a memory card controller 2041, which is equivalent to the storage module control element 211, and the Smart Card chip 204 is formed. And the accessing device so formed is also the copyright control card 220 referred to in the present invention. As having been mentioned above, the present invention is not intended to provide its own memory card specification, but to modify other existing memory card specifications. The following description is made based on the existing memory cards of SD/MMC. However, it is understood other existing memory cards, such as Memory Stick, CF Card, Smart Media Card, etc., may also be used in the present invention.

Since the SD card is one of the products subsequently developed from the MMC, it provides some modes compatible with the MMC. However, both the SD card and the MMC are memory cards using a Serial Bus interface anyway, and have some reserved instructions. In the embodiment shown in FIG. 9, it is intended to change these reserved instructions into self-defined expanded instructions to control the access of a copyright control chip.

In actual use of the present invention, both the SD card and the MMC normally use hardware compatible with 8051 mono chip or use MCU as a basic configuration for the controller on the memory card. Generally, there are several I/O ports included in this type of microprocessor configuration. One of the I/O ports is used as the serial bus interface for the memory card, two of which are used to access the flash memory, and the remaining one of which is used to emulate the Smart Card interface for exchanging data with the Smart Card.

If there were not such I/O ports, it is not difficult to add one using the existing IC techniques. As to the copyright control chip, Java Card platform, which is the currently most popular Smart Card configuration, is used. Since the present invention is not intended to position a complete Smart Card in the unit, but to use the functions of the Smart Card, the present invention needs only to connect the Smart Card chip to the SC/MMC chip and then packages the two chips at the same time.

The Java Card platform is used in the present invention because it is currently recognized as the safest and most convenient Smart Card configuration for use. Since the Java Card is primarily used to execute the Java Applet stored in the memory, the present invention needs only to implement the copyright control mechanism using the Java programming language. Another advantage of using the java Card is the Java Applet may be very conveniently amended at any time during a developing stage and may be easily upgraded in the future. On the other hand, the Java Card provides a strict security mechanism that stops people who do not understand Java Card platform or do not have the authority to access the Java Applet from accessing the Java Applet of the present invention and the contents stored in the memory.

On the other hand, when the present invention uses an SD/MMC expanded instruction set to access information on the copyright control chip via an SC/MMC controller, it is also possible to exclude any authority to any illegal user at the time of designing the instruction set. As a result, any one who attempts to decrypt the present invention has to decrypt both the security mechanism provided by the Java Card and the SD/MMC controller specific to the present invention. Moreover, since the standard SC/MMC controller is used as a basic configuration in the present invention, the present invention is compatible with all the currently commercially available SD/MMC memory cards.

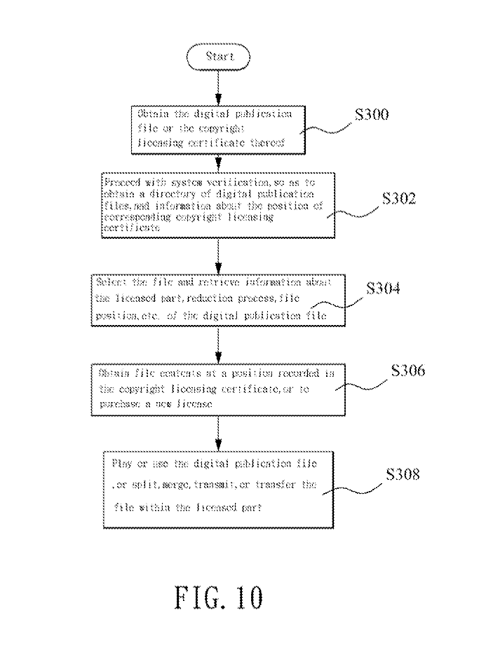

Please refer to FIG. 10 that is a flowchart showing the steps of using a digital publication according to a method of the present invention for protecting copyright of digital publication. In implementing the method of protecting copyright of digital publication provided by the present invention, at least one operational unit 300 is used to play, use, or access a digital publication file 100. The steps included in the method for using the digital publication file are as follows:

S300: To obtain the digital publication file 100 or the copyright licensing certificate 200 thereof.

A user may obtain the digital publication file 100 either by purchasing it in a store, or by connecting to the multimedia gate server 400 or the file server 503 at the remote digital publication service center 500 to download the digital publication file 100 or the copyright licensing certificate 200 thereof.

The user may obtain the digital publication file 100 or the copyright licensing certificate 200 when purchasing a device having the digital publication file 100 or the copyright licensing certificate 200 stored therein. Or, the user may obtain the digital publication file 100 or the copyright licensing certificate 200 by purchasing the above-mentioned device and then purchasing, merging, or taking over the digital publication file 100 or the copyright licensing certificate 200 on other devices via a network system.

The devices that may have the digital publication file 100 and the copyright licensing certificate 200 stored thereon include the copyright control card 220, the removable storage device 230, the operational unit 300, and the multimedia gate server 400. The digital publication file 100 and the copyright licensing certificate 200 may be stored on the removable storage device 230, the operational unit 300 having a built-in storage module 301, or a storage module of the multimedia gate server 400; or be stored in a remote virtual disk on the network; or be directed to the source of a certain stream data.

For instance, when a user purchases a copyright control card 220 having license to 100 movies stored in the certification module 201 thereof, he or she has obtained the license to the use of these 100 movies. Alternatively, the user may purchase the license to 100 movies via a network system, and stores the copyright licensing certificate 200 thereof on the certification module 201 of the copyright control card 22, while the file containing the movies is either stored on a remote virtual disk on the network or simply at a source of a stream data.

In another example, when a removable storage device 230 having 100 songs and corresponding license of use stored therein is purchased, the copyright licensing certificate 200 of these 100 songs has already been stored in the certification module 201 of the removable storage device 230, and the corresponding digital publication file 100 has already been stored in the memory of the removable storage device 230. Alternatively, the user may purchase the 100 songs via a network system, and then stores the digital publication file 100 and the copyright licensing certificate 200 of the 100 songs in the memory and the certification module 201 of the removable storage device 230, respectively.

Thus, when it is desired to use these 100 songs, it is not necessary for the user to locate the digital publication file 100 at a remote position on the network or the multimedia gate server 400. The user needs only to direct the file position to the removable storage device 230. The removable storage device 230 has a certification module 201 that has the same functions as the copyright control card 220, and therefore has all the functions of the copyright control card 220.

When an operational unit 300 has a built-in storage module 301, it is able to provide the same storage function as the removable storage device 230. Otherwise, the operational unit 300 could provide only the same functions as the copyright control card 220. However, when the operational unit 300 allows the removable storage device 230 or the copyright control card 220 to connect thereto, it may have expanded storage functions depending on the device actually connected thereto.

S302: To proceed with system verification, so as to obtain information about file directory, position of licensing certificate, etc.

When the user intends to play, use, or access the digital publication file 100, the operational unit 300 would first check for system compatibility. When the system compatibility is successfully verified, the operational unit 300 may then read out data about the digital publication file 100 and information about licensing, or obtain the copyright licensing certificate 200 at the position as recorded in the digital publication file 100. The operational unit 300 would then obtain the contents of the digital publication file 100 as well as the process of reducing the digital publication file 100 according to the information and position as recorded in the copyright licensing certificate 200. At this point, when the file format permits, the user may further select whether to store the digital publication file 100 at other positions. Of course, the file must be stored in a format the same as that before file reduction.

S304: To select the file and retrieve information about the licensed part, reduction process, file position, etc.

To use the digital publication file 100, the operational unit 300 has to request its own certification module 302, the removable storage device 230, or the copyright control card 220 to provide a directory of currently available digital publication, files 100. The removable storage device 230 or the copyright control card 220 would not provide the stored directory of digital publication file 100 and full relating information, such as the number of copyright licenses corresponding to the files 100, unless the system compatibility has been successfully verified. However, the system compatibility would always be successfully verified when the request for verifying system compatibility is made to the certification module 301 on the operational unit 300.

When the operational unit 300 is not compatible with the system of the present invention for protecting copyright of digital publication, the removable storage device 230 or the copyright control card 220 could only provide a simple digital publication directory stored therein without corresponding licensing details. Meanwhile, the result from the verification of system compatibility may also be used as a basis for the operational unit 300 to decide whether to access the removable storage device 230 or the copyright control card 220 using a manner protected by the present invention.

When the removable storage device 230 or the copyright control card 220 is not compatible with the copyright protection system of the present invention, the operational unit 300 would then use a general storage device to access the removable storage device 230 or the copyright control card 220 so that it may be compatible with the old system.

S306: To obtain file contents at a position recorded in the licensing certificate, or to purchase a new license.

When a desired digital publication file 100 has been selected, the operational unit 300 starts inspecting the copyright licensing certificate 200. In the event the license exists and does not exceed a specified scope of use, the operational unit 300 is provided with information about the process of reducing the digital publication file 100 and the position at where the digital publication file 100 is stored, so as to get the contents of the digital publication file 100. Reversely, in the event the license is insufficient, the user is prompted to stop using or wait for using the digital publication file 100, or to purchase a new license for the digital publication file 100.

In the event the user selects to purchase a new license, the digital publication file 100 may be then used within the licensed part provided by the purchased new license. On the other hand, in the event the user refuses to purchase a new license or is not willing to wait for use, but to arbitrarily use the file 100, the operational unit 300 would either output only the DEMO part of the digital publication file 100 or refuse to output the digital publication file or other related parts thereof.

S308: To play or use the file or to split, merge, transmit, or transfer the file within the licensed part.

When the operational unit 300 completes certification of the copyright licensing certificate 200, licensing information is created. The user may play, use, or access the digital publication file 100, or split or merge the copyright licensing certificate 200 within the licensed part as specified in the licensing information. The copyright licensing certificate 200 may be split, merged, transmitted, or transferred directly on the operational unit 300 to create new licensing information.

For users, there are six different operations in connection with the copyright licensing certificate 200, namely, the obtaining, losing, splitting, merging, transmitting, and transferring of the copyright licensing certificate 200.
(a) The obtaining of copyright licensing certificate:
   The copyright licensing certificate 200 may be obtained in the following several conditions: (1) when a copyright control card 220, a removable storage device 230, and an operational unit 300 having the copyright licensing certificate 200 stored thereon is purchase, including those purchased in a secondhand merchandise market; (2) when the copyright licensing certificate 200 is purchased online and downloaded and stored in a previously purchased copyright control card 220, removable storage device 230, and operational unit 300; and (3) when the copyright control card 220, removable storage device 230, and operational unit 300 containing the copyright licensing certificate 200 are obtained from someone else as a donation. Or, it is also possible to obtain the copyright from someone else as a donation, such as to succeed to other's copyright license to the digital publication file 100, and then complete the donated copyright through splitting, merging, transmitting, etc. of the copyright.
(b) The losing of copyright licensing certificate:
   A user might lose the copyright licensing certificate 200 in the following several conditions: (1) the copyright licensing certificate 200 is expired and no longer valid; (2) the user gives the digital publication file 100 and the corresponding copyright licensing certificate 200 to someone else as a donation; and (3) the user gives up the ownership of the digital publication file 100 and the corresponding copyright licensing certificate 200.
(c) The splitting of copyright licensing certificate:
   By “splitting the copyright licensing certificate 200”, it means the copyright licensing certificate 200 already owned by the user and stored in a device or unit is divided into two or more parts for separately storing on two or more different devices or units. Generally speaking, the purchased digital publication file 100 and the corresponding copyright licensing certificate 200 are not limited to be used as a whole, but may be split according to actual state of use for using on and between different devices or units at the same time, or completing the donation of a part of or the whole digital publication file 100 and the licensing thereof to other users.
(d) The merging of copyright licensing certificate:
   There are two conditions of merging: (1) to merge several copyright licensing certificates 200 that are created for the same digital publication file 100 and already owned by the user but are separately stored on two or more different devices or units; and (2) to merge a digital publication file 100 and the corresponding copyright licensing certificate 200, that are owned by the user and stored on one device or unit, in another digital publication file 100 and the corresponding copyright licensing certificate 200 that are to be purchased soon. With the merging operation, the user may conveniently manage the owned digital publication file 100 and corresponding copyright licensing certificate 200, or purchase new or accept donated digital publication file 100 and corresponding copyright licensing certificate 200.
(e) The transmitting of copyright licensing certificate:
   By “transmitting the copyright licensing certificate”, it means the whole or a part of the copyright licensing certificate 200 stored on a first device or unit is passed to another one or more devices or units without changing the owner of the copyright licensing certificate 200, that is, a licensee. Usually, the copyright is split on the device or the unit providing the copyright licensing certificate 200, and then merged on other devices or units.
(f) The transferring of copyright licensing certificate:
   The transferring of copyright licensing certificate 200 is similar to the transmitting of copyright licensing certificate 200, except that the owner of the copyright licensing certificate 200, that is, a licensee, must be changed when the copyright licensing certificate 200 is transferred. In the case of a named copyright licensing certificate 200, the transferring is a required operation in the donation or purchase of the copyright.

In brief, in the method and system of the present invention for protecting copyright of digital publication, the copyright licensing certificate 200 is split or merged based on the legal copyright recorded therein for use on one or more operational units 300, so that the operational units 300 always legally play, use, or access the digital publication file 100 according to the copyright licensing certificate 200, and any illegal reproduction of the digital publication file 100 is stopped. More specifically, when a licensing certificate is split or merged, a copyright-providing operational unit in a plurality of online operational units may transmit or transfer the split or the merged copyright to other copyright-sharing operational units according to the licensing information in the copyright licensing certificate. By way of temporarily or permanently merging or splitting the licensing certificate among different operational units, the target of legally sharing the copyright may be achieved.

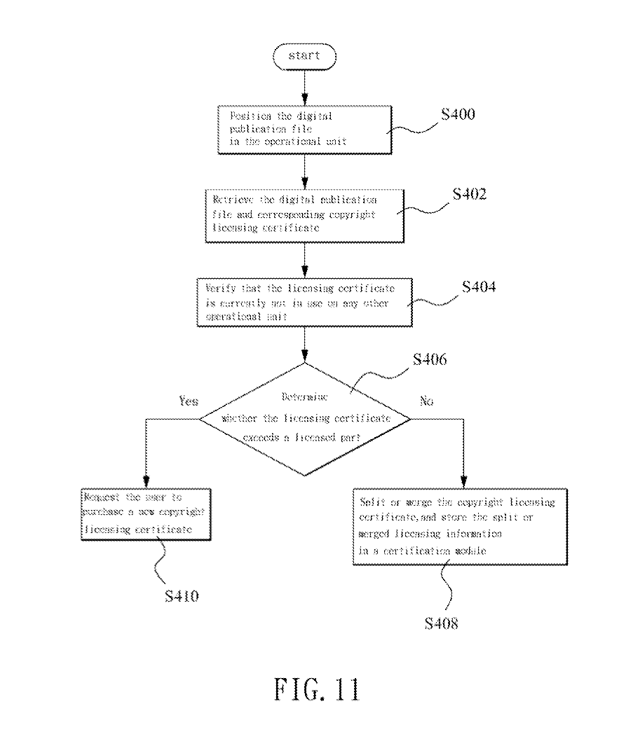

Please refer to FIG. 11 that is a flowchart showing the steps of splitting or merging the copyright licensing certificates 200 according to the method of the present invention. As shown, the steps include:

S400: Position the digital publication file 100 in the operational unit 300.

When a user intends to play, use, or access the digital publication 100 on the operational unit 300, the user has to obtain the licensing information and the contents of the digital publication file 100 as mentioned before, and position the same in the operational unit 300.

S402: Retrieve the digital publication file and corresponding copyright licensing certificate 200.

The operational unit 300 would then retrieve the digital publication file 100 and the corresponding copyright licensing certificate 200.

S404: Verify that the licensing certificate is currently not in use on any other operational unit.

Before performing any operation against the licensing certificate 200, it must be verified the copyright licensing certificate 200 is currently not used on any other operational unit 300. In the event the copyright licensing certificate 200 is currently used on other operational unit, it is necessary to forcibly cease the operation against the copyright licensing certificate 200.

S406: Determine whether the licensing certificate exceeds a licensed part.

The operational unit 300 would determine whether the use of the copyright licensing certificate 200 exceeds a licensed part.

S408: Split or merge the copyright licensing certificate 200, and store the split or merged licensing information in a certification module.

When it is determined the copyright licensing certificate 200 does not exceed the licensed part, then the copyright licensing certificate 200 is split or merged, and the split or merged licensing information is stored in the removable storage device 230, the copyright control card 220, or the operational unit 300.

S410: Request the user to purchase new copyright licensing certificate 200.

When it is found the copyright licensing certificate 200 is no longer effective, or the split or merged copyright licensing certificate exceeds the licensed part of the original licensing certificate 200, the user is requested to stop the splitting or merging operation until a new copyright licensing certificate allowing the splitting or merging operation has been purchased or provided.

A copyright may be shared in any one of three different states, namely, offline, online, and mixed states. In the mixed state, offline and online states exist at the same time. It is temporarily defined in the present invention that when it is desired to share the copyright in the offline state, the sharing must be done in an environment having at least one multimedia gate server 400.

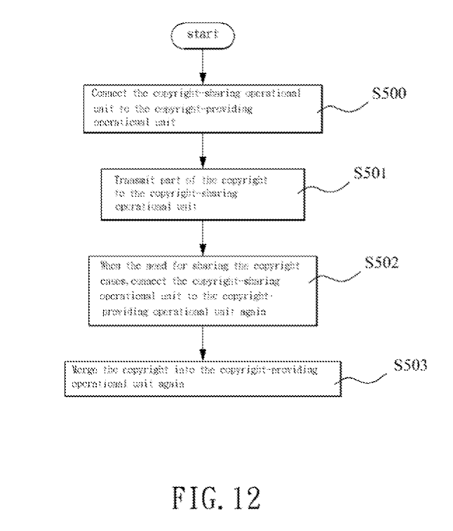

FIG. 12 is a flowchart showing the steps of sharing the copyright licensing certificate 200 in the offline state according to the method of the present invention. When a copyright-sharing operational unit 300 has obtained the digital publication file 100 and the corresponding copyright licensing certificate 200 from another copyright-providing operational unit 300, and requests for using the digital publication file 100 and the copyright licensing certificate 200 when it has been disconnected from the copyright-providing operational unit 300, a need for sharing copyright in an offline state occurs.

To share a copyright offline, first connect the copyright-sharing operational unit 300 to the copyright-providing operational unit 300 (S500), and then proceed with splitting of the copyright on the copyright-providing operational unit 300, so as to transmit part of the copyright to the copyright-sharing operational unit 300 (S501). When the need for sharing the copyright ceases, the copyright-sharing operational unit 300 is connected to the copyright-providing operational unit 300 again (S502). Then, a copyright merging operation is performed, so that the part of copyright that was split and provided to the copyright-sharing operational unit 300 is merged into the copyright-providing operational unit 300 again to complete one cycle of sharing a copyright in the offline state (S503). In the event the shared part of the copyright is actually the whole copyright, it is also possible to transmit the copyright to the copyright-sharing operational unit 300, and then transmit the copyright from the latter to the copyright-providing operational unit 300 again when the sharing ceases.

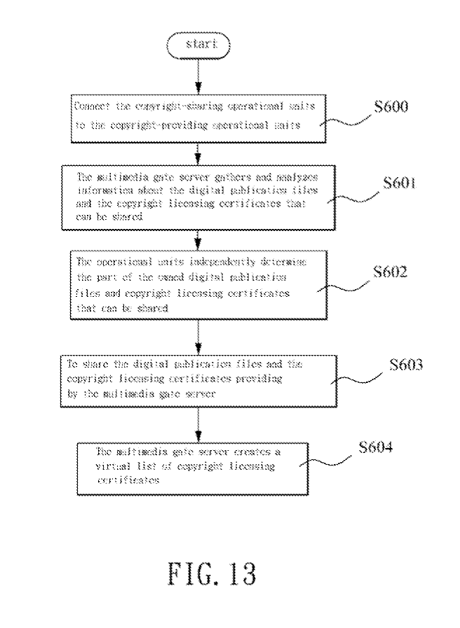

FIG. 13 is a flowchart showing the steps of sharing the copyright licensing certificate in the online state according to the method of the present invention. To share the copyright in the online state, all the copyright-sharing operational units 300 are connected to the copyright-providing operational unit 300 in the process of sharing the copyright (S600). The sharing of copyright in the online state must be done in an environment having at least one multimedia gate server 400, because there must be an apparatus to check and control the licensed part and the use state of the digital publication file 100 on all the operational units 300 connected to the copyright-providing operational unit 300 from time to time.

The multimedia gate server 400 is very suitable for this purpose in terms of its defined function. And, the online apparatus are mainly connected to one another via local area networks, short-distance wireless signal connection, and direct connection between two apparatus via connecting ports. As to the connection via Internet, it is only suitable for the connection between two or more multimedia gate servers 400.

When all the copyright-sharing operational units 300 are connected to the multimedia gate server 400, the multimedia gate server 400 would gather and analyze information about the digital publication files 100 and the copyright licensing certificates 200 that can be shared on the connected copyright-sharing operational units 300 (S601). The operational units 300 may independently determine the part of the digital publication files 100 and copyright licensing certificates 200 owned by them that can be provided for sharing with other operational units 300 (S602). Alternatively, the operational units 300 may determine just to share in the digital publication files 100 and the copyright licensing certificates 200 provided by the multimedia gate server 400 or other operational units 300 (S603).

When the multimedia gate server 400 has obtained the statistical information about the digital publication files 100 and the copyright licensing certificates 200 that are available for sharing among all the connected operational units 300, a virtual list of copyright licensing certificates is created (S604), allowing the operational units 300 to start sharing or sharing in the digital publication files 100 according to the virtual list of copyright licensing certificates 200 provided by the multimedia gate server 400. When an operational unit 300 wants to use a digital publication file 100 that is available for sharing, one of the following conditions might occur in standard procedures of using the file 100:
1. The operational unit 300 would first check whether it owns the digital publication file 100 and the copyright licensing certificate 200 thereof. If yes, and there are still parts in the licensing information labeled as available for use, the operational unit 300 would then start using the digital publication file 100. At this point, the licensing information is labeled as in use. And, when the operational unit 300 ends the use of the digital publication file 100, the licensing information is labeled as available for use again.
2. The operational unit 300 owns the digital publication file 100 and the copyright licensing certificate 200, but the licensing information is labeled as in use. At this point, the operational unit 300 would check with the multimedia gate server 400 for any other available copyright licensing certificate 200. If yes, the operational unit 300 would then start using the digital publication file 100, and have the other licensing information labeled as in use via the multimedia gate server 400. The other licensing information is labeled as available for use again when the use of the digital publication file 100 ends.
3. The operational unit 300 owns the digital publication file 100 and the copyright licensing certificate 200, but a result from the check with the multimedia gate server 400 indicates no effective licensing information is currently available for use. At this point, since the sharing of the license has been agreed, the operational unit 300 could not use the digital publication file 100 and the copyright licensing certificate 200 until other operational units 300 cease using the same.
4. The operational unit 300 does not own the digital publication file 100 and the copyright licensing certificate 200, and directly checks with the multimedia gate server 400 for any available digital publication file 100 and any copyright licensing certificate 200 available for sharing. If yes, the operational unit 300 would then start using the digital publication file 100 and have the available licensing information labeled as in use via the multimedia gate server 400. The licensing information would be labeled as available for use again when the use of the digital publication file 100 ends.
5. The operational unit 300 does not own the digital publication file 100 and the copyright licensing certificate 200, and directly checks with the multimedia gate server 400 for any other operational unit 300 that has a copyright licensing certificate 200 available for sharing. If there is currently not any effective copyright licensing certificate 200 available for sharing, then the operational unit 300 could not use the digital publication file 100 and the copyright licensing certificate 200 until other operational units 300 cease using the same.
6. Both the operational unit 300 and the multimedia gate server 400 do not have effective copyright licensing certificate 200 available for use. At this point, a request may be made to a remote digital publication service center via the multimedia gate server 400 for purchasing a new copyright licensing certificate 200 for use.

The multimedia gate server 400 has several functions, such as (1) providing the space for storing large quantities of digital publication files 100 and copyright licensing certificates 200; (2) allowing the connected operational units 300 to purchase or use digital publication files 100 and copyright licensing certificates 200 online via the multimedia gate server 400; (3) allowing the digital publication files 100 and the copyright licensing certificates 200 to be shared between the multimedia gate server 400 and the connected operational units 300; and (4) cooperating with other multimedia gate servers 400 in the sharing and controlling of the copyright licensing certificates 200, particularly when the multimedia gate servers 400 are connected to Internet.

Generally speaking, since the multimedia gate server 400 has the functions of connecting to the multimedia service center on the Internet, and enabling the sharing of digital publication files 100 and copyright licensing certificates 200, it has the ability to store large quantities of digital publication files 100 and copyright licensing certificates 200. Thus, when the connected operational units 300 do not have the ability of storage, they may still use the digital publication files 100 and the copyright licensing certificates 200 via the multimedia gate servers 400.

The operational unit 300 may always be connected to the Internet via the multimedia gate server 400, no matter whether it is online-enable. Therefore, the operational unit 300 would automatically check whether it owns the digital publication file 100 and the copyright licensing certificate 200 when it is used to play, use, or access the file 100. Typically, the operational unit 300 would show a list of digital publication files for a user to determine whether the desired digital publication file 100 is included in the list.

If the desired digital publication file 100 and the corresponding copyright licensing certificate 200 are not included in the list of the operational unit 300, the operational unit 300 may check with a connected multimedia gate server 400 for a list of digital publication files 100 available from the multimedia gate server 400. In the event the desired digital publication file 100 is not found, or the corresponding copyright licensing certificate 200 has an insufficient licensed part, the operational unit 300 may be then connected to a multimedia service center on the Internet via the multimedia gate server 400 for locating the desired digital publication file 100 and purchasing or adding the copyright licensing certificate 200.

When the desired digital publication file 100 comes from a remote storage location on the Internet or a stream data source, an operational unit 300 without the ability of connecting to the Internet would no doubt rely on the Internet-connecting function of the multimedia gate server 400 to obtain the remote digital publication file on the Internet.

Since the multimedia gate server 400 usually has the ability of storing large quantities of digital publication files 100 and copyright licensing certificates 200, it is a common practice in implementing the present invention to share the digital publication files 100 and the copyright licensing certificates 200 stored on the multimedia gate server 400.

Generally speaking, in a family-based application of the present invention, only one multimedia gate server 400 is enough for use. As a matter of fact, in the general licensing concept, a householder is deemed as the representative of a family. Thus, it is only reasonable when a copyright licensing certificate 200 is allowed for sharing in a family-based house. Therefore, a family-oriented multimedia gate server 400 is configured only to allow the connected operational units 300 to share the digital publication files 100 and the copyright licensing certificates 200.

However, for a business, a big-scale organization, or a government office that usually has employees or members working at different places, the use of a local area network (LAN) might not be enough to cover all the users. Thus, it is necessary to use an independent LAN in each separate zone or building of the business, the organization, or the government office. Under this circumstance, it is preferable to use a LAN or a building as a unit in controlling and sharing the copyright licensing certificates 200 in a business, a big-scale organization, or a government office, and allow all units thereof to have their own multimedia gate server 400.

These multimedia gate servers 400, on the one hand, control the sharing of the digital publication files 100 and the copyright licensing certificates 200 among all the internal operational units 300, and, on the other hand, constantly interact with other or higher layer multimedia gate servers 400 to dynamically adjust the digital publication files 100 and the copyright licensing certificates 200 owned by them, so as to satisfy all possible changes in the demand for sharing the digital publication files 100 and the copyright licensing certificates 200.

To the contrary, a family-oriented multimedia gate server 400 would cooperate with other multimedia gate servers 400 for copyright control only when a digital publication file 100 and the corresponding copyright licensing certificate 200 are purchase. At this point, the purchased digital publication file 100 and the copyright licensing certificate 200 are transmitted or transferred from the file server and copyright server of the multimedia service center to the family-oriented multimedia gate server 400. In some sense, the multimedia service center is the biggest multimedia gate server.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of protecting copyright of digital publication, including the playing, using, accessing or sharing of a digital publication file via an operational unit, and a copyright server of a digital publication service center; at least one copyright licensing certificate for controlling or limiting an authority of using at least one digital publication file in a normal way, the operational unit defined as a device, the device include a built-in storage module, a removable storage device, a play device control element, a digital publication file processing unit, a built-in certification module or a removable copyright control card, and the combinations thereof; the digital publication file include an advertisements and a demonstration part; When the digital publication file is played without the copyright licensing certificate, the output thereof includes the advertisements and the demonstration part of the digital publication file, and scrambled codes of a protected file content, and when the digital publication file is played with the copyright licensing certificate, the digital publication file sequence is reduced and readable data, including a digital publication file content and the demonstration part of the digital publication file are output, comprising:
(a) obtaining at least one copyright licensing certificate or file;
(b) verifying said copyright licensing certificate to obtain a licensed part of and an authority to use said digital publication file;
(c) splitting, merging, transmitting, or transferring said copyright licensing certificate via said at least one operational unit within said licensed part as recorded in said copyright licensing certificate;
(d) playing, using, accessing or sharing said digital publication file within said licensed part; and
wherein the splitting of said copyright licensing certificate in the step (c) further includes the steps of connecting a plurality of said operational units to one another for operating, following licensing information on said copyright licensing certificate to split a copyright available on a first one of said operational units, namely, a copyright-providing operational unit, into several parts to be available for other ones of said operational units, namely, copyright-sharing operational units, and transmitting or transferring said split copyright from said copyright-providing operational unit to said copyright-sharing operational units;
wherein the merging of said copyright licensing certificate in the step (c) further includes the steps of connecting a plurality of said operational units to one another for operating, following licensing information on said copyright licensing certificate to merge several parts of a copyright previously scattered for use on said a plurality of operational units, namely, copyright-providing operational units, into a copyright available on one of said operational units, namely, a copyright-sharing operational unit, and transmitting or transferring said merged copyright from said copyright-providing operational units to said copyright-sharing operational unit;
wherein the transmitting of said copyright licensing certificate in the step (c) includes passing of a whole or a part of said copyright licensing certificate from a first said operational unit to another said operational unit without changing an owner of said copyright licensing certificate;
wherein the transferring of said copyright licensing certificate in the step (c) includes passing of a whole or a part of said copyright licensing certificate from a first said operational unit to another said operational unit while an owner of said copyright licensing certificate is changed at the same time;
wherein the step (a) further includes the step of storing the obtained copyright licensing certificate in a certification module.

2. The method of protecting copyright of digital publication as claimed in claim 1, wherein the step (a) further includes the step of obtaining said digital publication file at a file position recorded in said copyright licensing certificate after said copyright licensing certificate has been obtained.

3. The method of protecting copyright of digital publication as claimed in claim 1, wherein said file obtained in the step (a) includes the digital publication file having at least one information about the position of a obtaining copyright licensing certificate recorded therein, such that said copyright licensing certificate is obtained according to said recorded position.

4. The method of protecting copyright of digital publication as claimed in claim 1, wherein said copyright licensing certificate obtained in the step (a) is directly purchased in a store.

5. The method of protecting copyright of digital publication as claimed in claim 1, wherein the step (a) further includes the step of connecting said operational unit to a multimedia gateway server or the copyright server of a digital publication service center, so as to download and thereby obtain said copyright licensing certificate.

6. The method of protecting copyright of digital publication as claimed in claim 1, wherein said copyright licensing certificate is stored at a position selected from the group consisting of at least one copyright control card, at least one removable storage device, at least one operational unit, and at least one multimedia gateway server.

7. The method of protecting copyright of digital publication as claimed in claim 1, wherein the step (a) further includes the steps of connecting said operational unit to the multimedia gateway server or the file server of a remote digital publication service center, so as to download and obtain said digital publication file; and storing the obtained digital publication file in a storage module of the operational unit.

8. The method of protecting copyright of digital publication as claimed in claim 1, wherein the step (b) further includes the steps of requesting for directory of digital publication files and copyright licensing certificates; and selecting to operate the digital publication file and the copyright licensing certificate in said directory.

9. The method of protecting copyright of digital publication as claimed in claim 1, wherein the step (b) further includes the steps of providing said operational unit with a process or information of reproducing said digital publication file and information about storage position of said digital publication file that a license to the use of said digital publication file exists and said digital publication file is used within a licensed part thereof; and prompting a user to purchase a new license, or refusing to output said digital publication file, or outputting only a demonstration part of said digital publication file when an insufficient license is found.

10. The method of protecting copyright of digital publication as claimed in claim 1, wherein the copyright licensing certificate purchased in a store is preloaded into the certification module of the operational unit.

11. The method of protecting copyright of digital publication as claimed in claim 1, wherein the digital publication file includes an encrypted contents and a non-encrypted demonstration parts.

12. The method of protecting copyright of digital publication as claimed in claim 1, wherein the copyright licensing certificate is stored in a packaged certification module internally containing a Smart Card chip.
